(19) United States
(12) Patent Application Publication
(10) Pub. No.: US 2023/0187774 A1
(43) Pub. Date: Jun. 15, 2023

(54) TRACTION BATTERY COMPRISING A GUIDE MEANS FOR A FLUID VOLUME FLOW, AND MOTOR VEHICLE

(71) Applicant: KAUTEX TEXTRON GmbH & Co. KG, Bonn (DE)

(72) Inventors: Alexander PECHAN, Bonn (DE); Georg ENKIRCH, Salz (DE); Mario STRACK, Bonn (DE); Tobias VENNEFROHNE, Koln (DE)

(21) Appl. No.: 17/924,951

(22) PCT Filed: May 12, 2021
(86) PCT No.: PCT/EP2021/062647

§ 371 Date: Nov. 11, 2022

(30) Foreign Application Priority Data
May 14, 2020 (DE) 10 2020 113 086.4

(51) Int. Cl. H01M 50/367; H01M 50/209; H01M 50/342; H01M 50/271; H01M 10/653; H01M 10/655

(52) U.S. Cl. CPC H01M 50/367; H01M 50/209; H01M 50/3425; H01M 50/271; H01M 10/653; H01M 10/655

(57) ABSTRACT

A traction battery including a battery shell and a plurality of battery modules arranged in the battery shell. Each battery module has a safety valve. The traction battery also includes a battery cover and a ventilation element for aerating and/or venting the traction battery. The traction battery has a guide means, which is regularly permeable, at least in part, to a designated fluid volume flow, for deflecting a designated fluid volume flow emerging in a designated manner from a safety valve in the direction of the ventilation element. The traction battery has a venting channel which extends from the guide means to the ventilation element.

The invention relates to a traction battery comprising a guide means for a fluid volume flow and to a motor vehicle.

In particular, the invention relates to a traction battery having a guide means, which is regularly permeable at least in part to a designated fluid volume flow, for deflecting a designated fluid volume flow emerging from a safety valve in the direction of the ventilation element, the traction battery also having a venting channel which extends from the guide means to the ventilation element.

In hybrid motor vehicles and/or electric vehicles, electrochemical energy stores with a high voltage level and/or high energy density are predominantly used, in particular in the form of lithium-ion accumulators, the storable amounts of energy per unit volume (energy density) increasing with the further development of the electrochemical energy stores used.

If, in an electrochemical energy store, in particular in a lithium-ion accumulator with a liquid, solid or bound electrolyte, there is a local short circuit of the internal electrodes, the short-circuit current through the internal resistor can heat up the vicinity of the point of the short circuit to such an extent that the surrounding regions are also affected. This process can expand and quickly release the energy stored in the accumulator in the form of heat, in particular the stored electrical and chemical energy. This release of heat, which often occurs exponentially, is also referred to in technical language as thermally irreversible escalation or as thermal runaway or more generally as a thermal event.

The thermal stability of electrochemical energy stores is often inversely proportional to the amount of energy stored per unit volume, which means that thermal stability is becoming increasingly important in the development of new electrochemical energy stores.

Traction batteries known in the prior art have a plurality of battery modules, each having one or more electrochemical battery cells. Many known traction batteries are still equipped without safety elements against error propagation of thermal events.

If a thermal event occurs in one of the battery modules of a traction battery, the amount of heat released can be transferred to adjacent battery modules, which means that adjacent battery modules and/or battery cells can also heat up until a thermally irreversible escalation begins. The energy can be transferred both by direct thermal conduction between the battery modules and also indirectly via a fluid that may be emerging from a battery module. It is significant whether and how the fluid comes into contact with other battery modules after emerging from a battery module. In the case of a thermal event in a battery module, there is generally a risk of a chain reaction, which can lead to a total failure of the traction battery.

In order to reduce the probability of such a chain reaction, suitable measures can be provided which, in the case of a thermal event, are intended to reduce the transfer of heat flow from one battery module to an adjacent battery module and are therefore also suitable for increasing the safety and thus the availability of a traction battery.

The object of the invention is that of providing an improvement over or an alternative to the prior art. In this case, the transfer of thermal energy via the fluid volume flow that may be emerging from one battery module to other battery modules is preferably reduced or prevented.

According to a first aspect of the invention, the object is achieved by a traction battery comprising
a battery shell
a plurality of battery modules arranged in the battery shell, each battery module having at least one safety valve,
a battery cover and
a ventilation element for aerating and/or venting the traction battery,
   wherein
the traction battery has a guide means, which is regularly permeable at least in part to a designated fluid volume flow, for deflecting a designated fluid volume flow emerging from a safety valve in the direction of the ventilation element,
the traction battery has a venting channel which extends from the guide means to the ventilation element.

In this regard, the following is explained conceptually:

It should first be expressly noted that in the context of the present patent application, indefinite articles and numbers such as “one,” “two,” etc. should generally be understood as “at least” statements, i.e. as “at least one . . . ,” “at least two . . . ,” etc., unless it is clear from the relevant context or it is obvious or technically imperative to a person skilled in the art that only “exactly one . . . ,” “exactly two . . . ,” etc. can be meant.

In the context of the present patent application, the expression “in particular” should always be understood as introducing an optional, preferred feature. The expression should not be understood to mean “specifically” or “namely.”

A “traction battery” is understood to mean an electrochemical energy store. A traction battery is preferably suitable for installation in and for driving electric vehicles and/or hybrid vehicles. A traction battery comprises a plurality of electrochemical battery modules.

A traction battery preferably has other parts or components that are necessary or beneficial for the operation of the traction battery, these other parts or components preferably being arranged inside the battery housing of the traction battery.

A “battery module” is understood to mean a component of a traction battery, the battery module having at least one electrochemical battery cell or a plurality of electrochemical battery cells.

A battery module preferably has an electrolyte barrier which encloses the reactive material of the battery module.

A battery module preferably also comprises a safety valve.

According to an expedient embodiment, a battery module has a plurality of electrolyte barriers, each of which has a separate safety valve and encloses part of the reactive material of the battery module, with each electrolyte barrier also preferably enclosing one or more battery cells.

A “safety valve” is understood to mean a valve which is designed to protect a battery module from an impermissible pressure increase. The safety valve opens when a defined response pressure in the battery module is exceeded or when a response differential pressure is reached between the battery module and the surroundings around the battery module. By opening the safety valve, the battery module is relieved, preferably before the structural integrity of the battery module is endangered.

If an overpressure occurs in a battery module having a safety valve, the safety valve opens and a fluid volume flow emerges from the battery module first into the battery housing. This reduces the pressure inside the battery module. Depending on the type of battery cell and/or battery module, in particular depending on the type of electrolyte used in the battery cell and/or battery module, the fluid volume flow emerging in a designated manner can be a designated fluid volume flow with different states of aggregation; in particular, it can be a gas, a gas mixture, an aerosol and/or a particle stream.

In particular, it is conceivable under certain boundary conditions that the designated fluid volume flow is flammable, i.e. can convert its chemical energy into thermal energy in an exothermic reaction.

Preferably, a safety valve has a bursting membrane, a bursting membrane being designed to break irreversibly at a defined pressure difference between the two sides of the bursting membrane, so that a fluid volume flow can flow through the bursting membrane after the bursting. In this way, a battery module can advantageously be protected from a damaging underpressure and/or overpressure.

A “battery cell” is understood to mean a store for electrical energy on an electrochemical basis, which store in each case has an electrode arrangement with a cathode contacting element and an anode contacting element. In this case, inside the battery cell, the cathode and the anode are preferably constructed in multiple layers, with the individual layers being stacked alternately and being electrically separated from one another by a suitable separator.

A “fluid volume flow” is understood to mean a material flow. The fluid volume flow indicates how much volume of a fluid is transported through a specified cross section per period of time.

A “designated fluid volume flow” is understood to mean the fluid volume flow which occurs when a safety valve of a battery module opens.

A designated fluid volume flow emerging from a safety valve is in particular also a heat flow, because the battery module has previously been heated up by the thermal event.

In particular, a designated fluid volume flow can have a particle flow if components of the battery module and/or the at least one battery cell have previously been heated up and broken down by the thermal event.

A “battery housing” is understood to mean a solid case for a traction battery which is designed to protectively enclose the components of the traction battery arranged within the battery case.

A battery housing preferably consists of a battery shell and a battery cover, it being possible for the battery shell and the battery cover to be connected to one another in an integral or form-fitting or force-fitting manner or to be designed to be connectable to one another.

According to a particularly expedient embodiment, the battery housing can be supplemented by further components, in particular by a plate element and/or a venting unit.

A battery housing preferably has at least one venting unit, which is designed for aerating and/or venting the traction battery and which has both a guide means and a venting channel. A venting unit preferably also has at least one ventilation element, through which a material flow can be exchanged between the interior of the battery housing and the surroundings of the battery housing. A venting unit can preferably be connected to the battery shell and/or the battery cover in an integral or form-fitting or force-fitting manner.

A battery housing preferably has a plurality of venting units, preferably each having at least one ventilation element.

A “battery shell” is understood to mean a housing component of a traction battery. In particular, a battery shell is designed to accommodate battery modules and/or battery cells of a traction battery so that they can be protected by the battery shell and/or fastened at least indirectly to a motor vehicle.

According to an expedient embodiment, a battery shell is also conceivable which has a substantially flat structure with one or more substantially flat planes, at least one plane of the battery shell being designed to accommodate battery modules and/or battery cells of a traction battery, such that these can be fastened at least indirectly to a motor vehicle by the battery shell. The battery housing of a battery shell designed in this way is preferably supplemented by a battery cover with a complementary shape, which, in combination with the battery shell, is advantageously designed to protect the battery modules and/or battery cells from external influences.

According to a particularly expedient embodiment, it is also conceivable, inter alia, for a battery shell to have a ventilation element.

A “battery cover” is understood to mean a component of a battery housing that is designed to close a battery shell. A battery cover is preferably designed to function as a removable closure for the battery shell. A battery cover is preferably shaped so as to complement a relevant battery shell in such a way that it is designed to protect the components accommodated in a battery housing from external influences, in particular to protect the battery modules and/or battery cells against external influences.

A battery cover is preferably designed to accommodate components of a traction battery.

In such a particularly preferred embodiment, a battery cover can be designed to accommodate battery modules and/or battery cells of a traction battery so that they can be protected by the battery cover and/or fastened at least indirectly to a motor vehicle.

Specifically, a traction battery is conceivable which, both in the battery shell and in the battery cover, is designed to accommodate and protect battery modules and/or battery cells. In this case, the housing component arranged below in the designated installation position of the traction battery is referred to as the battery shell and the housing component arranged above is referred to as the battery cover.

A battery cover preferably comprises a ventilation element.

A “ventilation element” is understood to mean a component or an assembly that is designed to aerate and/or vent the battery housing. A ventilation element can allow a material flow between the interior of the battery housing and the surroundings of the battery housing at any time. Furthermore, it is also conceivable that a ventilation element only allows a material flow through the ventilation element under certain boundary conditions, in particular only when a defined pressure difference between the interior of the battery housing and the surroundings of the battery housing is exceeded.

Preferably the ventilation element has a semi-permeable membrane.

A “semi-permeable membrane” is understood to mean a partially permeable wall which allows particles having a size below a size defined depending on the membrane to pass through the semi-permeable membrane, while particles having a size greater than this membrane-dependent size cannot pass through the membrane.

A semi-permeable membrane is preferably understood to mean a membrane which allows gas exchange, in particular air exchange, while the membrane is not permeable to liquids, in particular water, at least up to a membrane-dependent pressure difference between the two surfaces of the membrane, in particular up to a pressure difference of 0.05 bar, preferably up to a pressure difference of 0.1 bar, particularly preferably up to a pressure difference of 0.2 bar.

Preferably the ventilation element has a bursting membrane. Furthermore, a ventilation element preferably has a semi-permeable membrane and a bursting element, in particular in the form of a semi-permeable bursting membrane.

A bursting membrane within a ventilation element is designed to break irreversibly at a defined pressure difference between the two sides of the bursting membrane, so that a designated fluid volume flow can flow through the bursting membrane from the interior of the battery into the surroundings after the bursting. In this way, the battery housing can advantageously be protected from a damaging underpressure and/or overpressure.

Overall, a ventilation element in the form of a semi-permeable bursting membrane can advantageously be used to keep moisture out of the interior of the battery housing during regular operation of the traction battery, while aerating and venting of the battery housing can be ensured, and the ventilation element, in the event of a rapid pressure increase of the pressure difference above the bursting pressure difference, irreversibly breaks up and thus the structure of the battery housing is not endangered. Such a ventilation element can preferably be exchanged.

A “guide means” is understood to mean a means which is designed to deflect a designated fluid volume flow into the venting channel, the designated fluid volume flow preferably not accumulating in front of the guide means and/or in the guide means by means of an advantageous flow-mechanical design.

In other words, a guide means is designed to guide a designated fluid volume flow and thereby deflect it, ideally with the lowest possible total pressure loss of the designated fluid volume flow.

A “regularly permeable” guide means is understood to mean that the guide means regularly has a freely permeable cross section between the individual elements, in particular a plate and/or a deflection element and/or a deflection vane, of the guide means, which are each arranged offset to one another, through which cross section a designated fluid volume flow can flow.

An element or the elements of the guide means is/are preferably designed in such a way that a cross section through which the designated fluid volume flow can freely flow is arranged in the direct projection direction above a safety valve or each safety valve.

A guide means is preferably designed in such a way that a designated fluid volume flow preferably and/or predominantly flows out of the guide means in such a way that it flows out directed in the direction of the ventilation element.

A guide means is preferably configured and/or designed in such a way that flow separation of the designated fluid volume flow at the guide means is prevented before the designated fluid volume flow has reached the designated trailing edge of the guide means oriented in the direction of the ventilation element.

The guide means proposed here is preferably designed in terms of flow mechanics in such a way that the designated hot fluid volume flow and heat flow can flow back into a barrier region between the battery modules and the guide means only with difficulty.

According to a particularly preferred embodiment, a guide means is a stamped part made of metal or a molded part made of plastics material comprising metal and/or mica, as a result of which the heat resistance of the guide means can be advantageously improved.

A “barrier region” is understood to mean a region that extends between the guide means and the battery modules that do not thermally escalate or are not thermally escalated.

The barrier region is preferably designed to accommodate a thermal insulation layer consisting of a gas volume that is cold compared to a designated fluid volume flow.

In contrast to the barrier region, an “inflow region” is understood to mean a region between the thermally escalating battery module or the thermally escalated battery module and the guide means.

The inflow region is preferably delimited from the barrier region by the stream tube of the fluid volume flow emerging from the safety valve in a designated manner.

The inflow region is preferably comparatively small with respect to the barrier region.

The designated fluid volume flow of a thermally escalating or escalated battery module preferably flows out of the safety valve first into the inflow region.

Preferably, the guide means and/or at least one element of a guide means, in particular a plate and/or a deflection element and/or a deflection vane, has a trailing edge, i.e. the geometry of the guide means and/or the element of the guide means that is furthest downstream in the flow direction of a designated fluid volume flow, which geometry is designed in such a way that a designated fluid volume flow flows out in the tangential direction of the geometry, i.e. does not flow around it.

The trailing edge is preferably designed to be comparatively sharp-edged, i.e. in particular not roughly rounded.

The guide means proposed here is preferably formed from a fiber-reinforced plastics material, in particular based on polyamide. In addition to a guide means, which substantially consists of plastics material, embodiments are also conceivable in which a guide means is filled with fibers and/or has glass fibers and/or has carbon fibers and/or has natural fibers.

The guide means proposed here can preferably be integrated into the battery cover or other existing structural elements made of plastics material.

The guide means proposed here can preferably be produced using a plastics pressing method or an injection molding method. In some embodiments, the guide means proposed here can also advantageously be produced by metal die-casting.

A “deflection” of the designated fluid volume flow is understood to mean a change in direction of the designated fluid volume flow of at least 30°, preferably at least 50° and in particular at least 70°, compared to the designated exit direction out of the safety valve.

Preferably, the deflection of the designated fluid volume flow in interaction with the venting channel is almost 90°, preferably 90° and more preferably more than 90°.

A “venting channel” is understood to mean a channel through which a designated fluid volume flow can flow freely, i.e. which is barrier-free, and which is formed by side walls and the guide means, the venting channel leading from the guide means to the ventilation element, so that a designated fluid volume flow is introduced into the venting channel by means of the guide means, is guided from the venting channel to the ventilation element and can escape through the ventilation element into the surroundings of the traction battery.

In particular, the venting channel spatially separates a region within the venting channel from another region within the traction battery in which the battery cells are arranged, inter alia; however, a venting channel has one or more openings that regularly allow a flow between the two aforementioned regions.

So far, traction batteries have been known in the prior art that have a safety valve in a battery module, so that in the event of overpressure in a battery module, in particular as a result of a thermal event within the battery module, a designated fluid volume flow can be released from the battery module. Said flow initially flows into the free volume in the surroundings of the battery module in the interior of the battery housing.

Even if battery housings with a ventilation element for aerating and/or venting the free volume of the interior of the traction battery are already known in the prior art, the designated fluid volume flow is initially distributed predominantly completely in the free volume of the interior of the traction battery and only flows afterward out of the free volume of the battery housing according to any boundary conditions of the ventilation element.

In the case of embodiments of traction batteries known from the prior art, it could be observed that the designated fluid volume flow, which also entails a heat flow, emits this heat flow to a considerable extent to adjacent battery modules. As a result, neighboring battery modules and/or deviating battery modules also heat up additionally, as a result of which a thermal event can also occur in these battery modules. This can trigger a chain reaction, which can lead to the total failure of the traction battery.

Furthermore, traction batteries are known in the prior art which have a second, upstream safety valve in operative connection with the safety valve of the battery module, which second safety valve is intended to prevent a backflow of the designated fluid volume flow to the adjacent battery modules. However, this first requires a renewed increase in pressure in the region between the safety valve of the battery module and the second safety valve located above, as a result of which the designated fluid volume flow is initially calmed, loses kinetic energy in favor of additional heat production and can therefore also flow out of the traction battery more slowly.

The heat flow transferred from the designated fluid volume flow to adjacent battery modules also depends on the local proximity of the designated fluid volume flow and heat flow to an adjacent battery module and the residence time of the designated fluid volume flow and heat flow within the battery housing.

In this respect, it is advantageous for the designated fluid volume flow and heat flow to flow out of the battery housing particularly quickly, so that the probability of a chain reaction can be reduced and the availability of the traction battery can thus be increased.

By providing the guide means proposed here within the battery housing, the kinetic energy of the designated fluid volume flow emerging from the safety valve provided on the battery module can be ideally used to deflect the designated fluid volume flow and heat flow as quickly as possible so that it flows in the direction of the ventilation element; it is preferably guided at the same time, spaced as far as possible from the adjacent battery modules, through the venting channel to the ventilation element.

The guide means proposed here also means that the designated fluid volume flow between the safety valve arranged on the battery module and the ventilation element can be guided with the lowest possible total pressure loss, as a result of which the designated fluid volume flow and heat flow can flow out of the battery housing as quickly as possible.

The guide means is preferably designed such that the regularly permeable cross-sectional areas of the guide means through which a designated fluid volume flow can flow freely are arranged in a fluid-corresponding manner to the safety valve or valves, in particular are arranged in the projection direction of the safety valve or valves.

The overall low total pressure losses of the designated fluid volume flow and heat flow can be reduced by the fluid volume flow being guided without contractions and expansions of the flow tube, with deflections of the flow being well rounded by the guide means proposed here.

In other words, the guide means proposed here advantageously allows the designated fluid volume flow and heat flow, which flows out of the safety valve arranged on a battery module in the case of a thermal event, to be dissipated from the interior of the battery housing as quickly as possible without first having transferred a critical amount of heat to another battery module.

A chain reaction as a result of a thermal event in a battery module can thus be prevented or the probability of a chain reaction occurring can be at least significantly reduced.

If there is no chain reaction, the non-thermally escalated region of the battery modules can continue to be used, so that the traction battery can continue to be operated with limited capacity.

Furthermore, the number of additional components for guiding the designated fluid volume flow and heat flow can be advantageously reduced compared to solutions known in the prior art. This further reduces the testing and control effort for traction elements, since other valves, in particular second safety valves, do not have to be checked or monitored if they are not installed.

Overall, the general energy input to the adjacent battery modules can be reduced in this way, which reduces the probability of a thermal chain reaction of the remaining battery modules, which can also reduce the risk of fires and/or explosions.

In addition, the occurrence and spread of fire within the battery housing can be delayed or avoided, or at least the probability of fire occurring in the battery housing can be reduced.

According to the aspect of the invention proposed here, a traction battery is envisaged which has a safety valve for each battery module that corresponds to a guide means in a fluid-mechanical manner in such a way that the guide means is designed for deflecting a fluid volume flow emerging from the safety valve in a designated manner in the direction of the at least a ventilation element. A battery module can have one or more battery cells. The plurality of battery modules can particularly preferably be fastened in the battery shell and/or the battery cover.

Alternatively, a traction battery according to the aspect of the invention proposed here has a plurality of safety valves for at least one battery module, which safety valves correspond to a guide means in a fluid-mechanical manner in such a way that the guide means is designed for deflecting a fluid volume flow emerging from each safety valve in a designated manner in the direction of the at least one ventilation element. According to this alternative, too, a battery module can have one or more battery cells. The plurality of battery modules can particularly preferably be fastened in the battery shell and/or the battery cover here, too.

According to an expedient embodiment, the guide means has a plate at least in regions, with at least one component of a normal vector of the plate being aligned in the direction of the ventilation element.

In this regard, the following is explained conceptually:

A “plate” is understood to be a planar component region of the conductive means that is flat.

A plate preferably has no thickness distribution in its longitudinal extension direction. In other words, a plate is preferably not profiled.

However, it is also conceivable that a plate has profiling. In particular, in the case of a profiled plate, a droplet shape is considered, the rounded end of which is aligned in the direction of the safety valve, with the pointed end of the droplet being aligned in the direction of the ventilation element.

A “normal vector” is a vector that is perpendicular to a surface or partial surface, in particular to a surface or partial surface of the guide means. A “component of a normal vector” is understood to mean a directional component of the normal vector in a reference coordinate system, in particular in a Cartesian reference coordinate system. A spatial direction of the reference coordinate system preferably points in the direction of the ventilation element.

In other words, a guide means is proposed here which has a non-profiled or profiled plate at least in regions, at least one component of a normal vector of the plate being aligned in the direction of the ventilation element, while another component of the normal vector is aligned in the direction of the safety valve.

Due to the required alignment of the normal vector of the plate, it can advantageously be achieved that a designated fluid volume flow and heat flow emerging from a safety valve is deflected by the guide means in the direction of the ventilation element.

If the plate has a profiling, it is required that the normal vector of a region of the plate, which plate forms the guide means at least in regions, has a component which is aligned in the direction of the ventilation element, while another component of the normal vector is aligned in the direction of the safety valve.

Due to the droplet shape, it can advantageously be achieved that the designated fluid volume flow can be deflected in the direction of the ventilation element with a lower pressure loss compared to the embodiment with a non-profiled plate.

The guide means preferably has a deflection element which is formed by means of a plurality of connected plates.

In this regard, the following is explained conceptually:

A “deflection element” is understood to mean a specially shaped element of the guide means which is formed from a plurality of plates, in particular from two plates, preferably from three plates and particularly preferably from more than three plates, with the individual plates each having an angle not equal to 180° to one another. In other words, two adjacent plates each form an edge at their contact line. Preferably, this edge is well rounded, with the relevant rounding merging into a flat region on both sides, viewed in the direction of a designated fluid volume flow.

A deflection element preferably has a polygonal shape in cross section. Depending on the design, the polygonal shape has rounded corners.

The plates forming a deflection element are preferably connected to one another in one piece.

Using the element of a guide means proposed here, the designated fluid volume flow can advantageously be guided along the deflection element by means of several changes in direction. As a result, the individual changes in direction are smaller in comparison to a guide means in the form of a plate, as a result of which the total pressure loss of the designated fluid volume flow and heat flow can be reduced.

Furthermore, a more complex directional control of the designated fluid volume flow can be advantageously achieved with a deflection element, so that it is possible to react to complex geometric boundary conditions inside the traction battery. Complex geometric boundary conditions mean that the geometry cannot be described by a two-dimensional description and a direction of extension. As a result, the imaginary center line of a flow tube can show a three-dimensional deflection, so it does not lie completely in a single, arbitrary plane.

According to a particularly expedient embodiment, the guide means has a deflection vane.

In this regard, the following is explained conceptually:

A “deflection vane” has a body with a concave inner surface. In this case, the concave inner surface comprises at least one bend and is therefore designed to be curved in portions, the radius of curvature not necessarily being constant along the direction of longitudinal extent of the deflection vane. Alternatively or additionally, the concave inner surface can have at least one kink.

In this case, the at least one deflection vane, usually the concave inner side of the at least one deflection vane, is oriented in the direction of the ventilation element. In other words, the concave interior of the at least one deflection vane should face the ventilation element.

With the guide means proposed here in the form of a deflection vane, the total pressure loss of the designated fluid volume flow as a result of the deflection of the flow can be further advantageously reduced, in particular compared to a plate or a deflection element.

Particularly preferably, the deflection vane is profiled.

In this regard, the following is explained conceptually:

A “profiled” element of the guide means is understood to mean that the element, in particular the plate and/or the deflection element and/or the deflection vane, has a varying thickness distribution in the direction of the designated fluid volume flow from the safety valve to the ventilation element.

A profiled element of a guide means preferably has the thickness distribution of a droplet profile.

Preferably, the shape of a profiled deflection vane resembles a curved airfoil.

The inside of the deflection vane can be regarded as the “pressure side,” since the circulation-induced reduction in flow velocity on this side of the deflection vane due to geometry temporarily decreases, causing the static pressure acting on the deflection vane to increase locally as a result of the Bernoulli effect. In other words, the conservation of the specific energy of the fluid elements along a streamline means that a reduction in local flow velocity leads to an increase in pressure and vice versa. The opposite effect acts on the other side of the deflection vane. On the other hand, the flow velocity is increased locally, causing the static pressure to drop locally, which is why this side can also be referred to as the suction side. The underpressure on the suction side causes the flow to be sucked onto the contour of the deflection vane, which also causes a change in direction in the flow.

In this way, it can be advantageously achieved that the total pressure losses can be reduced again by deflecting the designated fluid volume flow as uniformly and gently as possible, in particular because a lower degree of turbulence can be achieved in the designated fluid volume flow, in particular in comparison to a plate or a deflection element or a non-profiled deflection vane as potential elements of the guide means.

Thus, the risk of a thermal chain reaction can be greatly reduced with a profiled deflection vane.

According to a particularly preferred embodiment, the guide means has a cascade of plates and/or deflection elements and/or deflection vanes.

In this regard, the following is explained conceptually:

A “cascade” is understood to mean a plurality of elements of the guide means which are each arranged offset to one another, so that a cross section through which a designated fluid volume flow can flow freely is formed between the individual elements.

A cascade is preferably formed by a plurality of plates.

Furthermore, a cascade is preferably formed by a plurality of deflection elements.

Particularly preferably, a cascade is formed by a plurality of deflection vanes, in particular by a plurality of profiled deflection vanes.

It should also be considered that a cascade can be formed by different elements. Thus, a cascade can equally be formed, inter alia, by a plurality of deflection vanes and/or deflection elements and/or plates.

The individual elements of the guide means are preferably arranged next to one another and in each case offset from one another, furthermore preferably with the same spacing between the individual elements.

Inter alia, however, a cascade of elements of a guide means is also considered which are not arranged equidistantly from one another, so that it is possible to react to specific geometric boundary conditions within the battery housing of the traction battery.

A cascade of elements of the guide means is preferably designed in such a way that a cross section through which the designated fluid volume flow can freely flow is arranged in the direct projection direction above each safety valve.

The individual elements of the guide means arranged in a cascade preferably have the same size.

However, a cascade should also be considered which has elements of the guide means with different sizes, so that the lowest possible total pressure loss can be advantageously achieved when deflecting the designated fluid volume flow, depending on the situation.

In other words, an aerodynamically designed deflection grid for a guide means in the form of a cascade of elements of the guide means is proposed here.

In this way, it can advantageously be achieved that a designated fluid volume flow can be guided particularly efficiently to the ventilation element, independently of the safety valve from which it emerges, as a result of which the risk of a thermal chain reaction can be particularly advantageously reduced.

The venting channel optionally extends above the guide means.

In this regard, the following is explained conceptually:

An extension of the venting channel “above” the guide means is understood to mean that the venting channel is arranged above and on the other side of the guide means from the point of view of a battery module. “Above” is explicitly not necessarily to be understood to mean above in the sense of the alignment when installed in the motor vehicle, in particular not in relation to the direction of gravity/gravitational acceleration. With respect to the overall alignment in the installed state, a venting channel according to this aspect of the invention can therefore also be arranged to the side and/or below.

In other words, in the case of a venting channel extending above the guiding means, the guiding means is designed to deflect the designated fluid volume flow from a direction flowing out of a safety valve in the direction of the ventilation element.

Advantageously, a very low total pressure loss of the designated fluid volume flow can be achieved on its route to be covered between the safety valve and the ventilation element, in particular because of the only slight and therefore particularly efficient deflection, due to geometry, of the hot designated fluid volume flow in the direction of the ventilation element.

Furthermore, it can advantageously be achieved that a barrier region between the battery modules and the guide means remains largely free of a hot fluid volume flow flowing out of a safety valve, as a result of which a thermal insulation region is created between the hot designated fluid volume flow in the venting channel and the battery modules, which are arranged to the side of the battery module from which the hot designated fluid volume flow flows out.

According to a particularly expedient embodiment, the ratio between a free cross section between two guide elements and the cross section between the inflow region and the at least one barrier region is greater than 1.

The ratio between a free cross section between two guide elements and the cross section between the inflow region and the at least one barrier region is preferably greater than 1.1, more preferably greater than 1.2, further preferably greater than 1.3, particularly preferably greater than 1.5, more particularly preferably greater than 1.7, and further particularly preferably greater than 2.0.

Furthermore, the ratio between a free cross section between two guide elements and the cross section between the inflow region and the at least one barrier region is preferably greater than 3, more preferably greater than 4, further preferably greater than 6, yet more preferably greater than 8 and particularly preferably greater than 10.

This can advantageously result in the total pressure loss of a designated fluid volume flow when flowing in the direction of the barrier region being higher than the total pressure loss of a designated fluid volume flow when flowing from the inflow region through the guide means in the direction of the venting channel. This advantageously allows the designated fluid volume flow to flow predominantly through the guide means in the direction of the venting channel and at the same time a thermally insulating layer can form in the barrier region, which layer can also advantageously reduce the tendency of adjacent battery modules to escalate as well.

The venting channel also optionally extends to the side of the guide means.

In this regard, the following is explained conceptually:

If the venting channel extends “to the side” of the guide means, this is understood to mean that the venting channel is arranged above the battery module from the point of view of a battery module; it also extends to the side of the guide means, which is also arranged above the battery module. From the point of view of the battery module, the venting channel is therefore arranged laterally next to the guide means.

In this case, the guide means is designed to deflect the fluid volume flow flowing out of the battery module in such a way that it is deflected into the venting channel with direction in the direction of the ventilation element.

In this way, an embodiment can advantageously be achieved which requires only a particularly small amount of space.

According to a particularly expedient embodiment, a guide means and/or an element of the guide means, in particular a plate and/or a deflection element and/or a deflection vane, is designed to deform when heat is applied, with a designated deformation being designed such that a cross section between two adjacent elements through which a designated fluid volume flow can flow freely is reduced and/or closed by the designated deformation.

The thermal deformation of the guide means proposed here is preferably designed in terms of flow mechanics in such a way that the designated hot fluid volume flow and heat flow can flow back into a barrier region between the battery modules and the guide means only with difficulty.

Inter alia, according to a particularly preferred embodiment, it should be considered that the thermal deformation of the guide means proposed here leads to the regularly permeable guide means having a guide element in the form of a plate and/or a deflection element and/or a deflection vane, which, after the thermally induced deformation, rests, in particular fluid-tightly, against its directly adjacent guide element. The thermal deformation can affect one or more or all guide elements of a guide means.

In this way, it can advantageously be achieved that the separation of the hot, designated fluid volume flow and heat flow can be further improved in relation to the adjacent battery modules, as a result of which the risk of a thermal chain reaction is further reduced.

According to an optional embodiment, the guide means is designed as a guide means unit.

In this regard, the following is explained conceptually:

An embodiment in which the guide means is designed as a “guide means unit” is understood to mean that the guide means is formed as a separate component or as a separate assembly. In other words, the guide unit is not formed in one method step together with the battery shell or the battery cover.

However, in a subsequent process step, the guide means unit can preferably be connected to the battery shell or the battery cover in an integral or form-fitting or force-fitting manner.

The guide unit is preferably designed to delimit the venting channel at least on one side in such a way that a designated fluid volume flow can flow through the guide means into the venting channel.

In this way, a particularly cost-effective production of the guide means can advantageously be achieved.

Furthermore, it can advantageously be achieved that the guide means can be retrofitted and/or replaced if necessary.

According to an expedient embodiment, the venting channel is formed in the battery cover.

In an embodiment in which the venting channel is formed in the battery cover, the battery cover preferably also has the ventilation element.

In this way, a robust component can advantageously be achieved which can be designed in a simple and compact manner.

Furthermore, this can advantageously reduce the assembly effort for the venting channel.

According to an optional embodiment, the venting channel and the guide means are formed in the battery cover.

Expediently, according to one of the embodiments described here, the battery cover preferably also has the ventilation element.

In addition to the battery cover, a plate element can preferably be formed, which is designed to cover, on one side, at least the region of the battery cover in which the venting channel and the guide means are arranged and thus preferably to form the venting channel.

According to a first variant, it should be considered that the battery cover is covered by a plate element on the side that faces the battery shell and thus preferably also the battery modules in a designated manner. This plate element can be connected to the battery cover in an integral or form-fitting or force-fitting manner. In this variant, the plate element has one or more openings and/or the plate element does not close the entire surface of the battery cover in the direction of the venting channel, so that a designated fluid volume flow can flow from the battery shell and thus from the battery modules into the venting channel.

According to a second variant, it should be considered that the battery cover can be closed by a plate element on its outside, i.e. on the side facing away from the battery modules. Furthermore, the battery cover in this embodiment can preferably have a region that is permeable to a designated fluid volume flow, via which region the designated fluid volume flow can flow from the battery module or the battery modules into the battery cover, in particular into the region of the battery cover that has the guide means and the venting channel. The plate element on the outside of the battery cover can be connected to the battery cover in an integral or form-fitting or force-fitting manner.

In this way, a robust component with integrated functionality can advantageously be achieved which can be designed in a simple and compact manner.

Furthermore, this can advantageously reduce the assembly effort for the venting channel and the guide means.

According to a further optional embodiment, the venting channel and the guide means are formed in a venting unit.

In this regard, the following is explained conceptually:

A “venting unit” is understood to mean a separate component or a separate assembly that accommodates the guide means and the venting channel. This separate component or assembly can be connected to the battery housing, in particular to the battery cover or battery shell.

In this way, a functionally optimized, compact and robust component can be advantageously achieved.

The battery shell and/or the battery cover preferably has at least one partition for separating at least two adjacent regions, at least one battery module (20, 22) being arranged in each of the at least two regions.

In this regard, the following is explained conceptually:

A “region” is understood to mean an accommodation volume for accommodating a battery module, which region is preferably separated from an adjacent region. Adjacent regions are particularly preferably not in fluid communication with one another. The wall thickness of a partition between two regions is preferably greater than or equal to 0.5 mm, preferably greater than or equal to 1 mm and particularly preferably greater than or equal to 1.5 mm. Furthermore, the wall thickness of a partition between two regions is preferably greater than or equal to 2 mm, preferably greater than or equal to 3 mm and particularly preferably greater than or equal to 4 mm.

A “partition ” is understood to mean an at least partial spatial separation between at least two adjacent regions, which is designed for thermal insulation between the at least two adjacent regions.

It should be considered, inter alia, that a partition separates adjacent regions, having at least having one battery module, in a designated manner, with a hot gas emerging in a designated manner from at least one of the separated battery modules flowing past a guide means into a common venting channel, so that a designated hot gas emerging from one or each of the battery modules of the battery modules separated by the partition can be discharged via a common venting channel. The guide means is preferably designed, in particular by its shape, such that a hot gas located in the venting channel cannot flow back into the region between a safety valve and the guide means.

Optionally, the battery shell is divided into at least two regions, at least one battery module being arranged in each of the at least two regions, the at least one battery module of each region being in fluid communication with a separate guide means and/or a separate venting channel.

Advantageously, it can be achieved that a hot gas volume flow emanating from a thermally escalating battery module can be discharged directly through a venting channel, in particular a separate venting channel, as a result of which the heat input into adjacent battery modules can be reduced.

A partition preferably consists of a long-fiber-reinforced polyamide. The at least one partition is preferably connected in one piece to the battery shell and/or the battery cover.

Each venting channel is preferably in fluid communication with a separate ventilation element.

This can advantageously be achieved in that after the event of a thermal escalation of a battery cell, one region of the traction battery can initially no longer be used, but another region can remain completely intact and consequently can also be used to transport the motor vehicle away or to continue operating the motor vehicle.

According to an expedient embodiment, the battery shell has a heat shield.

In this regard, the following is explained conceptually:

A “heat shield” is understood to mean a layer which is designed to protect a layer underneath this layer from thermal energy.

Expediently, a heat shield has a thickness of greater than or equal to 1 mm, more preferably greater than or equal to 1.5 mm and particularly preferably greater than or equal to 2 mm. Furthermore, a heat shield preferably has a thickness of greater than or equal to 2.5 mm, more preferably greater than or equal to 3 mm and particularly preferably greater than or equal to 3.5 mm.

A heat shield preferably comprises a particularly heat-resistant material, in particular mica and/or long-fiber-reinforced polyamide and/or metal, in particular steel. In concrete terms, this also includes heat shields that have a combination of a first layer made of long-fiber-reinforced polyamide and a second layer made of mica and/or metal, in particular steel.

A fiber of a long-fiber-reinforced polyamide preferably consists of a glass fiber and/or a carbon fiber and/or an aramid fiber and/or a basalt fiber. The fiber content of a long-fiber-reinforced heat protection layer is preferably a fiber volume proportion of greater than or equal to 40%.

It is preferably proposed to protect regions directly exposed to a designated hot gas with a heat shield. These can be found, for example, directly or indirectly above a safety valve.

A heat shield is expediently arranged in the venting channel. Furthermore, it is specifically conceivable that a guide means consists directly of a material of a heat shield.

The heat shield preferably has a stamped part made of metal or a molded/stamped part made of plastics material with local metal/mica shields.

The traction battery preferably has at least one heat accumulator, the heat accumulator having a thermal conductivity and a heat capacity.

In this regard, the following is explained conceptually:

A “heat accumulator” is understood to mean a store for thermal energy. In this case, the heat accumulator is designed to absorb thermal energy from the hot gas of a thermally escalating battery cell and/or a thermally escalating battery module and to release it again with a time delay.

A heat accumulator preferably comprises mineral wool or consists of mineral wool.

It can thus advantageously be achieved that a designated hot gas can be cooled down to such an extent before it emerges from the traction battery that the hot gas can reduce or prevent a hazard to the vehicle surroundings. Inter alia, a fuel tank in a hybrid vehicle is considered, which can be protected from a designated hot gas in this way.

This can also advantageously reduce the maximum heat flow from the hot gas of a thermally escalating battery cell and/or a thermally escalating battery module to the battery shell and/or the battery cover and/or the guide means and/or an adjacent battery module. In particular, this can contribute to the fact that the battery shell and/or the battery cover and/or the guide means are not softened or not excessively softened by the hot gas and/or adjacent battery modules do not likewise thermally escalate.

Optionally, the heat capacity of the heat accumulator is in a range of greater than or equal to 0.2 kJ/kgK and less than or equal to 1.2 kJ/kgK, preferably in a range of greater than or equal to 0.6 kJ/kgK and less than or equal to 1.1 kJ/kgK and particularly preferably in a range of greater than or equal to 0.8 kJ/kgK and less than or equal to 1.0 kJ/kgK.

Also optionally, the thermal conductivity of the heat accumulator is greater than or equal to 0.3 W/mK, preferably greater than or equal to 2 W/mK and particularly preferably greater than or equal to 5 W/mK.

A net and/or grid can preferably be provided on a heat accumulator, which net or grid, with its heat capacity and its comparatively large surface area that comes into contact with the hot gas, can absorb a particularly large heat flow and thus cool the hot gas particularly efficiently. The net and/or the grid preferably has metal fibers and/or glass fibers and/or basalt fibers.

Optionally, the heat accumulator is arranged in the venting channel of the traction battery. Advantageously, the effectiveness of the heat accumulator can thereby be used directly in the thermally particularly stressed venting channel.

The heat accumulator preferably has metal fibers and/or a metal grid, in particular metal fibers and/or a metal grid made of aluminum and/or copper.

A particularly robust and efficient heat accumulator can advantageously be achieved in this way.

Furthermore, a heat accumulator preferably has a core region and an edge region. The core region is preferably a latent heat accumulator and/or a thermochemical heat accumulator. The edge region particularly preferably has a metal mesh.

Advantageously, this means that a designated hot gas can be cooled particularly quickly due to the comparatively high thermal conductivity of the metal mesh and the comparatively high heat capacity of the core region can absorb a comparatively high amount of thermal energy.

The heat accumulator particularly preferably has a latent heat accumulator.

In this regard, the following is explained conceptually:

A “latent heat accumulator” is understood to mean a heat accumulator which does not or only slightly changes the perceptible outside temperature when absorbing and/or releasing thermal energy. A latent heat accumulator is preferably a heat accumulator which stores thermal energy through phase transition of a heat storage medium.

Thermal energy can thus advantageously be stored by the heat accumulator without the heat accumulator itself heating the battery shell and/or the battery cover and/or the guide means and/or an adjacent battery module.

The heat accumulator expediently has a thermochemical heat accumulator.

In this regard, the following is explained conceptually:

A “thermochemical heat accumulator” is understood to mean a heat accumulator that stores thermal energy by means of endothermic and exothermic reactions. A thermochemical heat accumulator preferably has a silica gel or a zeolite.

According to a second aspect of the invention, the task is solved by a motor vehicle having a traction battery according to the first aspect of the invention.

In this regard, the following is explained conceptually:

A “motor vehicle” is understood to mean a vehicle driven by a motor. A motor vehicle is preferably not mounted on a rail or at least not permanently track-mounted.

It goes without saying that the above-described advantages of a traction battery extend directly to a motor vehicle which has such a traction battery.

It should be expressly noted that the subject matter of the second aspect can advantageously be combined with the subject matter of the preceding aspect of the invention, both individually or cumulatively in any combination.

Further advantages, details and features of the invention can be found below in the described embodiments. In the drawings, in detail:

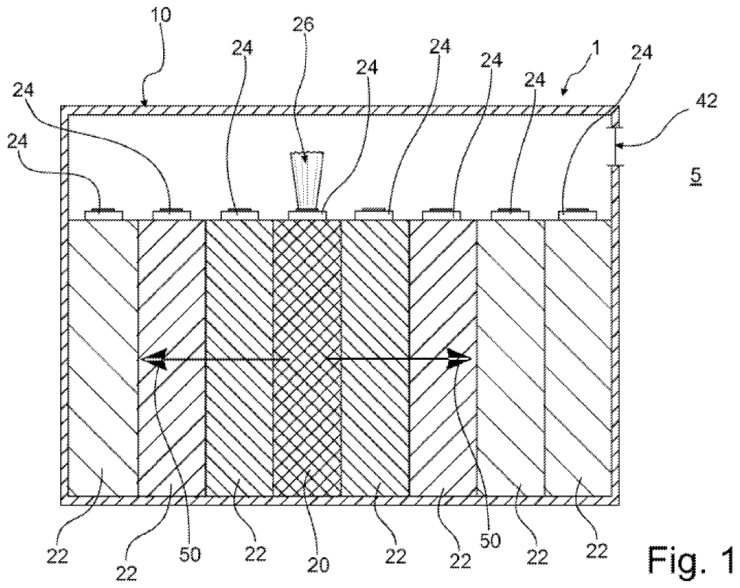

FIG. 1: schematically shows a first traction battery from the prior art;

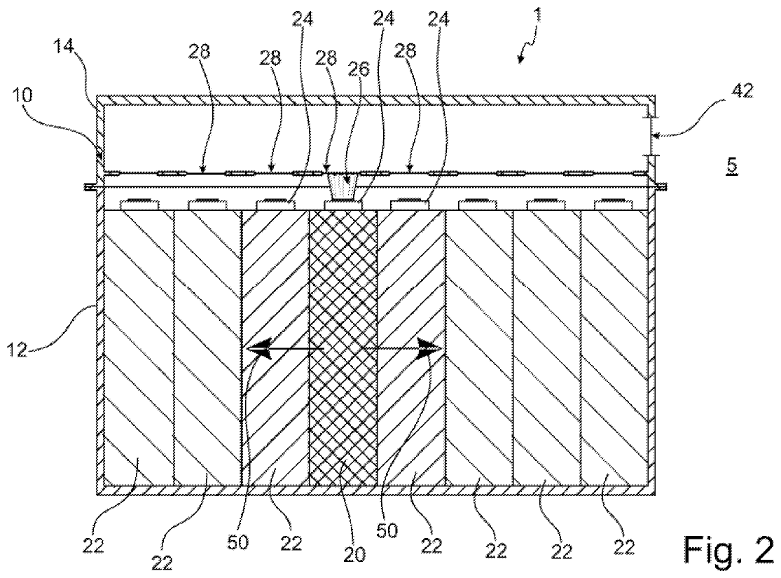

FIG. 2: schematically shows a second traction battery from the prior art;

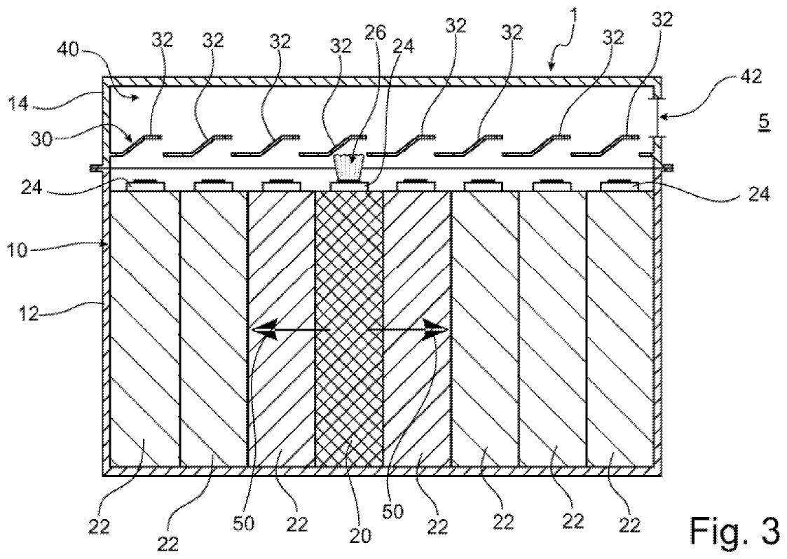

FIG. 3: schematically shows a traction battery having a guide means and a venting channel extending above the guide means;

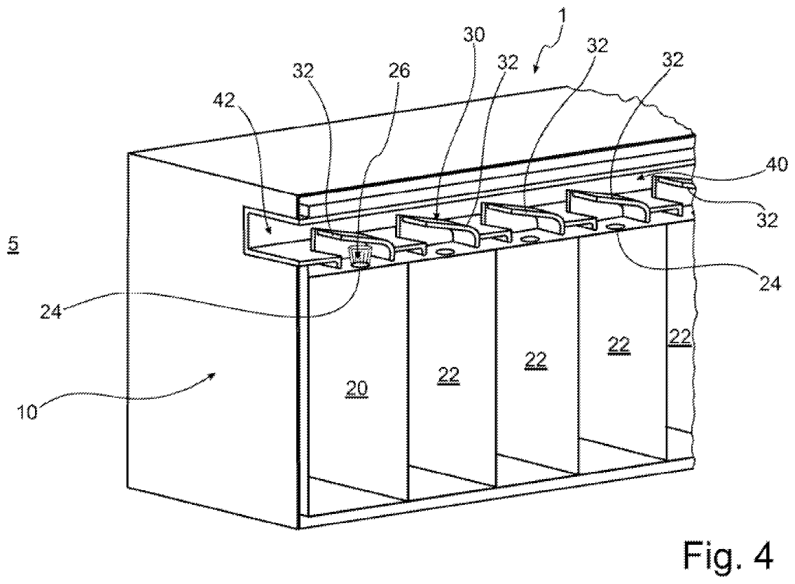

FIG. 4: is a perspective view of a traction battery having a guide means and a venting channel extending above the guide means;

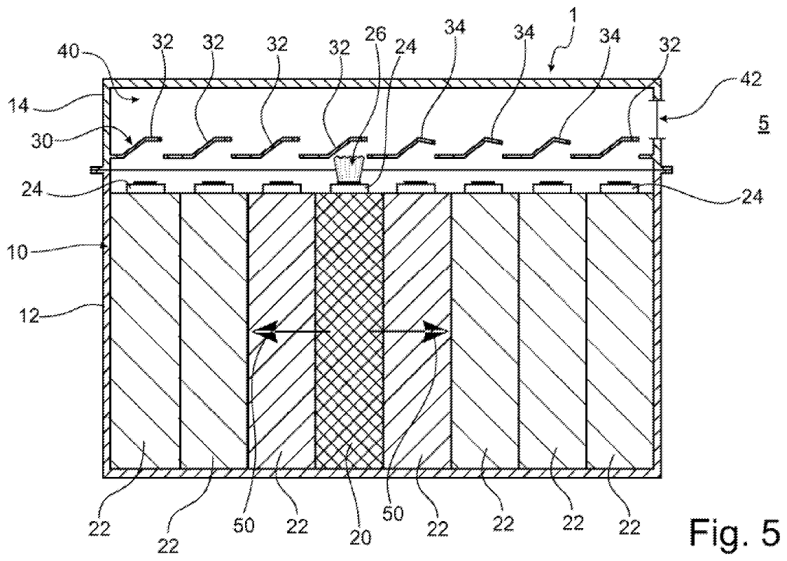

FIG. 5: schematically shows a traction battery having a guide means locally deformed by the application of heat;

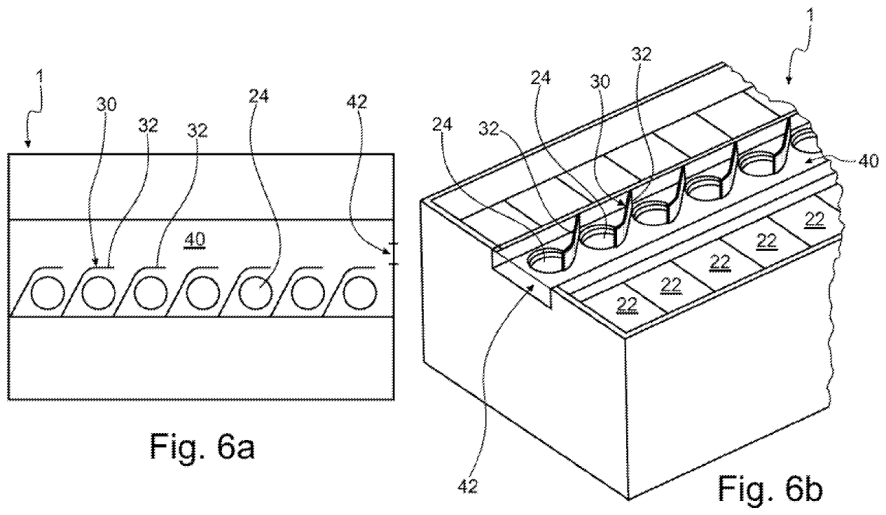

FIG. 6a: schematically shows a traction battery having a guide means and a venting channel extending to the side of the guide means;

FIG. 6b: is a perspective view of a traction battery having a guide means and a venting channel extending to the side of the guide means;

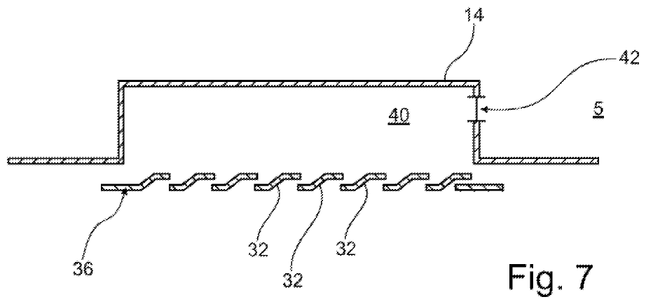

FIG. 7: schematically shows a battery cover having an integrated venting channel and a guide means unit;

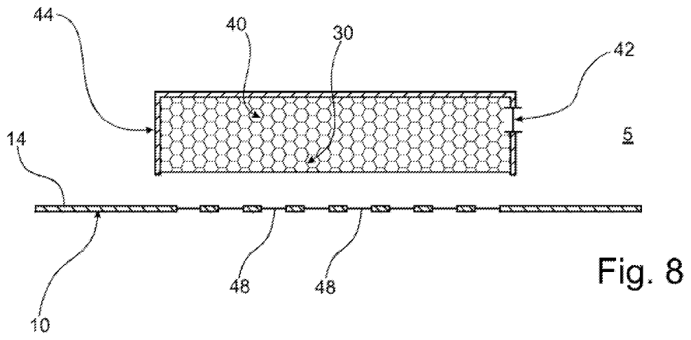

FIG. 8: schematically shows a venting unit with an integrated venting channel and guide means;

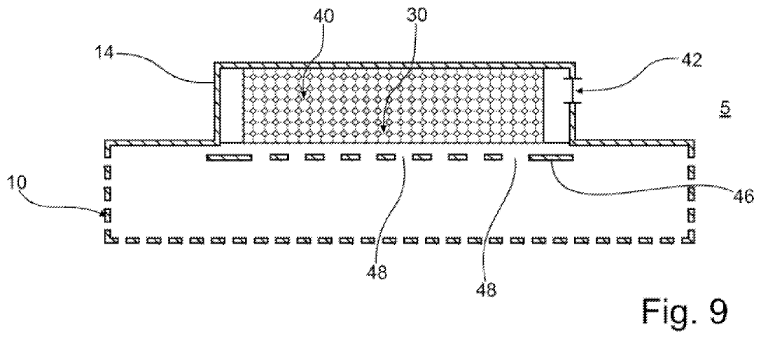

FIG. 9: schematically shows a battery cover having an integrated venting channel and guide means and an internal plate element; and

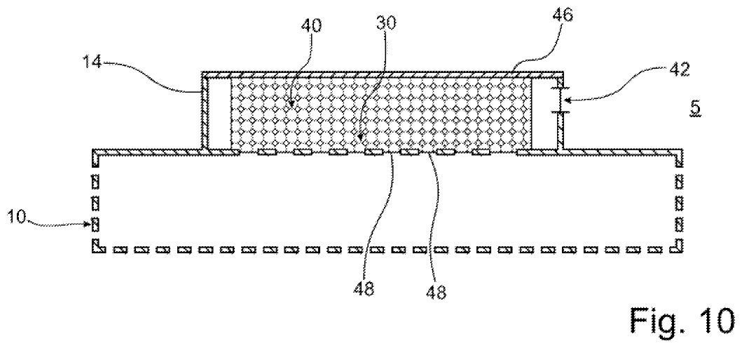

FIG. 10: schematically shows a battery cover having an integrated venting channel and guide means and an external plate element.

In the following description, the same reference signs denote the same components or features; in the interest of avoiding repetition, a description of a component made with reference to one drawing also applies to the other drawings. Furthermore, individual features that have been described in connection with one embodiment can also be used separately in other embodiments.

The traction battery 1 in FIG. 1 consists substantially of a battery housing 10 and a plurality of battery modules 20, 22, of which one battery module 20 is thermally escalated.

Each battery module 20, 22 has a separate safety valve 24 through which a designated fluid volume flow 26 can escape in the event of an imminent overpressure in the battery module 20, 22.

The battery housing 10 of the traction battery 1 has a ventilation element 42 through which the interior (not labeled) of the traction battery 1 can be aerated and vented relative to the surroundings 5 of the traction battery 1.

A designated fluid volume flow 26 flows out of the thermally escalated battery module 20 via the associated safety valve 24 into the interior (not labeled) of the battery housing 10.

The designated fluid volume flow 26 is not deflected in the traction battery 1, collides with the battery housing 10 and is initially distributed in the interior (not labeled) of the battery housing. As a result, the interior (not labeled) of the battery housing 10 heats up as a result of the heat flow (not labeled) carried along by the designated fluid volume flow 26, resulting in an acceleration of the thermal spread 50 from the thermally escalated battery module 20 to the adjacent battery modules 22.

If the adjacent battery modules 22 reach a critical temperature (not shown), the adjacent battery modules 22 can also thermally escalate. This can continue in the form of a chain reaction, which increases the risk of the traction battery 1 igniting.

The traction battery 1 in FIG. 2 has a battery housing 10 which consists of a battery shell 12 and a battery cover 14.

The battery cover 14 and the battery shell 12 are connected to one another in a form-fitting or force-fitting manner or integrally.

The battery cover 14 has a plane (not labeled) with a plurality of second safety valves 28 which delimit a barrier space (not labeled) between the battery modules 20, 22 and the plane (not labeled).

A second safety valve 28 preferably communicates with a safety valve 24 in each case.

In the event of a thermal escalation of the battery module 20, the safety valve 24 of the battery module 20 opens and a designated fluid volume flow 26 emerges from the battery module 20 and into the barrier space (not labeled) below the plane (not labeled) having the plurality of second safety valves 28.

From a defined overpressure in the barrier space, the second safety valve 28 above the safety valve 24 of the battery module 20 opens and the designated fluid volume flow 26 can find its way into the region above the plane (not labeled) and then continue through the ventilation element 42 into the surroundings 5 of the traction battery 1.

The traction battery 1 in FIG. 3 has a guide means 30 which has a plurality of elements of the guide means 32. The elements of the guide means 32 are deflection elements 32 which are arranged in a cascade (not labeled).

If there is a thermal escalation of the battery module 20 and a designated fluid volume flow 26 emerges via the safety valve 24 of the battery module 20, it is immediately deflected by the guide means 30 into the venting channel 40 in the direction of the ventilation element 42, from where it can escape into the surroundings 5 of the traction battery 1.

The venting channel 40 is designed to pass on the designated fluid volume flow 26 in the direction of the ventilation element 42 without major total pressure losses (not shown).

Below the guide means 30, a portion of the comparatively cold air (not shown) present before the thermal event remains next to the thermally escalated battery module 20 above the adjacent battery modules 22 and thus forms a barrier layer (not labeled) of cold air (not shown) within a barrier region (not labeled) with respect to the designated fluid volume flow 26, which barrier layer causes thermal insulation between the adjacent battery modules 22 and the designated fluid volume flow 26 in the venting channel 40 and thus reduces a heat flow (not shown) from the designated fluid volume flow 26 to the adjacent battery modules 22.

Accordingly, there is preferably a thermally insulating barrier layer (not labeled) between the guide means 30 and the non-thermally escalated battery modules 22 within the barrier region (not labeled) located there, which barrier layer advantageously extends between the comparatively hot designated fluid volume flow 26 and the thermally non-escalated battery modules 22.

In delimitation from the barrier region (not labeled), an inflow region (not labeled), into which the designated fluid volume flow 26 first flows from the safety valve 24, is located between the guide means 30 and the thermally escalated battery module 20.

The traction battery 1 in FIG. 4 is shown in perspective. The elements 32 of the guide means 30 are closed laterally, as a result of which a designated fluid volume flow 26 can be deflected even more effectively and with lower total pressure losses (not shown) into the venting channel 40 and guided in the direction of the ventilation element 42.

The traction battery 1 in FIG. 5 has a guide means 30 which has a plurality of thermally deformed elements 34 of the guide means 30.

The elements 34 of the guide means 30 are thermally deformed by the designated fluid volume flow 26 flowing above the guide means 30 through the venting channel 40 in the direction of the ventilation element 42.

The thermal deformation (not labeled) is so pronounced that a free cross section (not labeled) between two adjacent elements 34 of the guide means 30 and between the venting channel 40 and the barrier region (not labeled) is reduced or closed by the deformation (not labeled).

As a result, mixing of the designated fluid volume flow 26, which is hot compared to the air in the barrier layer (not labeled), can be reduced or prevented, as a result of which the thermal insulation of the barrier layer (not labeled) relative to the adjacent battery modules 22 can be improved.

Directly above the safety valve 24, from which the designated fluid volume flow 26 flows, the guide means 30 can preferably be deformed in the opposite way by the designated fluid volume flow 26, so that the free cross section through which the designated fluid volume flow 26 flows increases. Here, optionally and preferably, the free cross section of the venting channel 40 is also reduced in the direction facing away from ventilation element 42, as a result of which an undesired secondary flow of designated fluid volume flow 26 into the region of venting channel 40 facing away from ventilation element 42 can advantageously be reduced or prevented.

The traction battery 1 in FIGS. 6a and 6b has a venting channel 40 which is arranged to the side of the guide means 30. This is shown schematically in FIG. 6a and in perspective in FIG. 6b.

In the event of a thermal escalation of a battery module 22, a designated fluid volume flow (not shown) emerges via a safety valve 24 into the region of the guide means 30, where it is deflected by the interaction with the elements 32 of the guide means 30 into the venting channel 40 arranged to the side of the guide means 30 and from there passed on in the direction of the ventilation element 42 with the lowest possible further total pressure losses (not shown).

According to an alternative embodiment (not shown), it is also conceivable that a traction battery 1 in accordance with the traction battery 1 from FIGS. 6a and 6b also has a venting channel 40, which is arranged to the side of the guide means 30; instead of the safety valves 24 shown in FIGS. 6a and 6b, openings (not shown) are formed in each case.

In this case, battery modules 22 are arranged on the side of the openings (not shown) facing away from the guide means 30, which are preferably arranged such that they communicate with the openings (not shown). A barrier region (not shown) is provided here, which is arranged between the battery modules 22 and the guide means 30.

Inter alia, it should be specifically considered here that the venting channel 40 is arranged on the outside of the battery shell 12 and can be separated from the surroundings of the traction battery 1 by a cover and/or a ventilation element.

The venting channel 40 in FIG. 7 is formed directly in the battery cover 14.

The guide means (not labeled) is formed with its elements 32 in the form of a guide means unit 36 as a separate component or as a separate assembly group in relation to the battery cover 14.

The guide means unit 36 can be connected to the battery cover 14 in an integral, form-fitting or force-fitting manner so that a designated fluid volume flow (not shown) can be deflected via the guide means unit 36 into the venting channel and from there can leave the battery cover 14 through the ventilation element 42 into the surroundings 5 of the battery cover 14.

The guide means unit preferably has a stamped part made of metal or a molded/stamped part made of plastics material with local metal/mica shields, as a result of which the heat protection can be improved.

The venting unit 44 in FIG. 8 already contains, in the form of a compact and robust unit, a venting channel 40 formed in the venting unit 44 (only placeholders in the form of a honeycomb structure shown), a guide means 30 (only placeholders in the form of a honeycomb structure shown) and a ventilation element 42 for aerating and/or venting with the surroundings 5.

The guide means 30 (only placeholders in the form of a honeycomb structure shown) and venting channel 40 (only placeholders in the form of a honeycomb structure shown) can, in addition to other variants that are also conceivable, be designed in the form of a guide means 30 and/or a venting channel 40 which are each individually specifically known from one of FIGS. 3 and/or 4 and/or 5 and/or 6a and/or 6b.

Furthermore, it is also conceivable that the guide means 30 (only placeholders in the form of a honeycomb structure shown) and the venting channel 40 (only placeholders in the form of a honeycomb structure shown) are implemented by means of a guide means unit 36 known from FIG. 7 and a venting channel 40 known from FIG. 7.

The venting unit 44 can be connected to a battery housing 10, in particular to the battery cover 14, in a form-fitting or integral or force-fitting manner from the outside.

In the connection region (not labeled), the battery housing 10 has a plurality of openings 48 through which a designated fluid volume flow (not shown) can enter the venting unit 44 from the battery housing 10.

The battery cover 14 in FIG. 9 has a venting channel 40 (only placeholders in the form of a honeycomb structure shown), a guide means 30 (only placeholders in the form of a honeycomb structure shown) and a ventilation element 42 for aerating and venting the battery housing 10 with the surroundings 5.

The venting channel 40 (only placeholders in the form of a honeycomb structure shown) and guide means 30 (only placeholders in the form of a honeycomb structure shown) can be formed directly in the battery cover 14 together with the battery cover 14 or in series therewith. In this expedient embodiment, in particular if the venting channel 40 is arranged to the side of the guide means 30 (according to FIG. 6a/b), the venting channel 40 and the guide means 30 can be produced in one piece together with the battery cover 14 in a primary molding process (in particular injection molding and/or compression molding and/or extrusion).

The venting channel 40 (only placeholders in the form of a honeycomb structure shown) and guide means 30 (only placeholders in the form of a honeycomb structure shown) can be covered by a plate element 46, which has a plurality of openings 48, on the inside (not labeled) of the battery cover 14, as a result of which the venting channel 40 can also be completed first in a particularly advantageous embodiment.

The guide means 30 (only placeholders in the form of a honeycomb structure shown) and venting channel 40 (only placeholders in the form of a honeycomb structure shown) can, in addition to other variants that are also conceivable, be designed in the form of a guide means 30 and/or a venting channel 40 which are each individually specifically known from one of FIGS. 3 and/or 4 and/or 5 and/or 6a and/or 6b.

Furthermore, it is also conceivable that the guide means 30 (only placeholders in the form of a honeycomb structure shown) and the venting channel 40 (only placeholders in the form of a honeycomb structure shown) are implemented by means of a guide means unit 36 known from FIG. 7 and a venting channel 40 known from FIG. 7.

The plate element 46 can be connected to the battery cover in an integral or form-fitting or force-fitting manner 14.

A designated fluid volume flow (not shown) can flow out of the battery housing 10 through the plurality of openings 48 in the plate element 46 into the guide means 30 (only placeholders in the form of a honeycomb structure shown) and thus also the venting channel 40 (only placeholders in the form of a honeycomb structure shown).

The battery cover 14 in FIG. 10 has a venting channel 40 (only placeholders in the form of a honeycomb structure shown), a guide means 30 (only placeholders in the form of a honeycomb structure shown) and a ventilation element 42 for aerating and venting the battery housing 10 with the surroundings 5.

The venting channel 40 (only placeholders in the form of a honeycomb structure shown) and guide means 30 (only placeholders in the form of a honeycomb structure shown) can be formed directly in the battery cover 14 together with the battery cover 14 or in series therewith. In this expedient embodiment, in particular if the venting channel 40 is arranged to the side of the guide means 30 (according to FIG. 6a/b), the venting channel 40 and the guide means 30 can be produced in one piece together with the battery cover 14 in a primary molding process (in particular injection molding and/or compression molding and/or extrusion).

In this case, the guide means 30 (only placeholders in the form of a honeycomb structure shown) can, in addition to other variants that are also conceivable, be designed in the form of a guide means 30 which is individually specifically known from one of FIGS. 3 and/or 4 and/or 5 and/or 6a and/or 6b.

Furthermore, it is also conceivable that the guide means 30 (only placeholders in the form of a honeycomb structure shown) is implemented by means of a guide means unit 36 known from FIG. 7.

The venting channel 40 can be delimited by the plate element 46 in addition to other conceivable design variants. Inter alia, an embodiment of a venting channel 40 which is known from one of FIGS. 3 and/or 4 and/or 5 and/or 6a and/or 6b should also be considered.

In particular, it should be considered, inter alia, to delimit a venting channel 40 known from FIGS. 6a and/or 6b with the plate element 46.

The venting channel 40 (only placeholders in the form of a honeycomb structure shown) and guide means 30 (only placeholders in the form of a honeycomb structure shown) can be covered by a plate element 46 on the outside of the battery cover 14, as a result of which the venting channel 40 can also be completed first in a particularly advantageous embodiment.

The plate element 46 can be connected to the battery cover 14 in an integral or form-fitting or force-fitting manner.

In the region of the guide means 30 (only placeholders in the form of a honeycomb structure shown), the battery cover has a plurality of openings 48 through which a designated fluid volume flow (not shown) can flow out of the battery housing 10 into the guide means 30 (only placeholders in the form of a honeycomb structure shown) and thus also the venting channel 40 (only placeholders in the form of a honeycomb structure shown).

### LIST OF REFERENCE SIGNS

1 traction battery
5 surroundings of the traction battery
10 battery housing
12 battery shell
14 battery cover
20 battery module, thermally escalated
22 battery module
24 safety valve
26 designated fluid volume flow
28 second safety valve
30 guide means
32 element of guide means, plate, deflection element, deflection vane
34 element of guide means, thermally deformed
36 guide means unit
40 venting channel
42 ventilation element
44 venting unit
46 plate element
48 opening
50 thermal spread

1. A traction battery comprising:
a battery shell;
a plurality of battery modules arranged in the battery shell, each battery module having at least one safety valve;
a battery cover;
a ventilation element for aerating and/or venting the traction battery;
a guide means which is regularly permeable at least in part to a designated fluid volume flow, for deflecting a designated fluid volume flow emerging from a safety valve in the direction of the ventilation element; and
a venting channel which extends from the guide means to the ventilation element,
wherein the ventilation element has a semi-permeable membrane.

2. The traction battery according to claim 1, wherein the guide means has a plate at least in regions, with at least one component of a normal vector of the plate being aligned in the direction of the ventilation element.

3. The traction battery according to claim 1, wherein the guide means has a deflection element which is formed of a plurality of connected plates.

4. The traction battery according to claim 1, wherein the guide means has a deflection vane.

5. The traction battery according to claim 4, wherein the deflection vane is profiled.

6. The traction battery according to claim 1, wherein the guide means has a cascade of plates and/or deflection elements and/or deflection vanes.

7. The traction battery according to claim 1, wherein the venting channel extends above the guide means.

8. The traction battery according to claim 1, wherein the venting channel extends to a side of the guide means.

9. The traction battery according to claim 1, wherein the guide means and/or an element of the guide means, including at least one of a plate, a deflection element, or a deflection vane, deforms when heat is applied, with a designated deformation such that a cross section between two adjacent elements, through which a designated fluid volume flow can flow freely, is reduced and/or closed by the designated deformation.

10. The traction battery according to claim 1, wherein the guide means is a guide means unit.

11. The traction battery according to claim 1, wherein the venting channel is formed in the battery cover.

12. The traction battery according to claim 1, wherein the venting channel and the guide means are formed in the battery cover.

13. The traction battery according to claim 1, wherein the venting channel and the guide means are formed in a venting unit.

14. The traction battery according to claim 1, wherein the battery shell and/or the battery cover has at least one partition for separating at least two adjacent regions, at least one battery module being arranged in each of the at least two adjacent regions.

15. The traction battery according to claim 1, wherein the battery shell is divided into at least two regions, at least one battery module being arranged in each of the at least two regions, the at least one battery module of each region being in fluid communication with a separate guide means and/or a separate venting channel.

16. The traction battery according to claim 15, wherein each respective separate venting channel is in fluid communication with a respective separate ventilation element.

17. The traction battery according to claim 1, wherein the battery shell has a heat shield.

18. The traction battery according to claim 1, wherein the traction battery has at least one heat accumulator, the heat accumulator having a thermal conductivity and a thermal capacity.

19. The traction battery according to claim 18, wherein the heat capacity of the heat accumulator is in a range of greater than or equal to 0.2 kJ/kgK and less than or equal to 1.2 kJ/kgK.

20. The traction battery according to claim 18, wherein the thermal conductivity of the heat accumulator is greater than or equal to 0.3 W/mK.

21. The traction battery according to claim 18, wherein the heat accumulator is arranged in the venting channel of the traction battery.

22. The traction battery according to claim 18, wherein the heat accumulator has metal fibers and/or a metal grid, made of at least one of aluminum or copper.

23. The traction battery according to claim 18, wherein the heat accumulator has a latent heat accumulator.

24. The traction battery according to claim 18, wherein the heat accumulator has a thermochemical heat accumulator.

25. A motor vehicle comprising:
a traction battery including:
a battery shell,
a plurality of battery modules arranged in the battery shell, each battery module having at least one safety valve,
a battery cover,
a ventilation element for aerating and/or venting the traction battery,
a guide means which is regularly permeable at least in part to a designated fluid volume flow, for deflecting a designated fluid volume flow emerging from a safety valve in the direction of the ventilation element, and
a venting channel which extends from the guide means to the ventilation element.
